(19) United States
(12) Patent Application Publication
(10) Pub. No.: US 2026/0269411 A1
(43) Pub. Date: Sep. 10, 2026

(54) TEMPERATURE-CONTROL DEVICE FOR A BATTERY SYSTEM HAVING A MAIN BODY AND A PLURALITY OF BEARING SLEEVES ARRANGED IN A FLOW CHANNEL

(71) Applicant: John Deere Electric Powertrain LLC, Moline, IL (US)

(72) Inventor: Andreas Peter Pröll, Helfenberg (AT)

(21) Appl. No.: 19/165,533

(22) PCT Filed: Mar. 14, 2024
(86) PCT No.: PCT/EP2024/056844

§ 371 Date: Sep. 15, 2025

(30) Foreign Application Priority Data
Mar. 16, 2023 (AT) 50202/2023

(51) Int. Cl. H01M 50/291; H01M 10/613; H01M 10/643; H01M 10/6568; H01M 50/213; H01M 50/342

(52) U.S. Cl. CPC H01M 50/291; H01M 10/613; H01M 10/643; H01M 10/6568; H01M 50/213; H01M 50/3425

(57) ABSTRACT

A temperature control device for a battery system has a base body (1) and a plurality of bearing sleeves (2) for battery cells (3), which bearing sleeves (2) are arranged in a flow channel (4). A wall section (8) of the base body (1) is pierced by a receiving opening (7) which opens into a bearing sleeve of said plurality of bearing sleeves (2). The bearing sleeve (2) is formed from the wall section (8) of the base body (1).

### FIELD OF THE INVENTION

The invention relates to a temperature control device for a battery system having a base body and a plurality of bearing sleeves for battery cells, the plurality of bearing sleeves being in a flow channel, wherein a wall section of the base body is pierced by a receiving opening that opens into a bearing sleeve.

### DESCRIPTION OF THE PRIOR ART

The prior art discloses temperature control devices having a base body that forms bearing sleeves. DE102011017375A1 shows a temperature control device with such a base body, which is designed without a base plate and cover plate and has several bearing sleeves that are connected to the base body via webs. These webs also delimit several flow channels that run parallel to the longitudinal axes of the battery cells. In order to form a fluid-tight flow channel and to mechanically fix the battery cells, a separate base plate and cover plate are provided, which fix the battery cells in the bearing sleeves, at least one plate having openings aligned with the bearing sleeves for electrical contacting.

However, a disadvantage of the prior art is that the bearing sleeves are costly to manufacture due to their one-piece production with the base body. In order to facilitate production and achieve good heat transfer to the battery cells, it is known from the prior art to manufacture the base body from metal for this reason. Apart from the relatively high weight of the temperature control device that this results in, which makes it unattractive for use in the field of electromobility, electrical insulation of the battery cells is made significantly more difficult, in particular because cooling fluids with good thermal conductivity properties are also electrically conductive and therefore cannot be used in combination with electrically conductive base bodies. Although it is also known from DE102011017375A1 to provide the bearing sleeves with an insulating layer on their inner side, this further complicates the manufacturing process and in turn reduces the thermal conductivity.

US 2013/004820 A1 discloses a temperature control device for a battery system. This temperature control device has a base body and several bearing sleeves for battery cells, which bearing sleeves are arranged in a flow channel. Both cover sides of the base body are pierced by receiving openings that open into the bearing sleeves.

### SUMMARY OF THE INVENTION

The invention is therefore based on the task of producing a temperature control device with an integrated cooling fluid flow channel that is as light, simple, and inexpensive to manufacture as possible.

The invention solves the problem by forming the bearing sleeve from the wall section of the base body. As a result of these measures, the base body, which consists, for example, of a one-piece or integrally manufactured hollow body, can form a fluid-tight flow channel together with the bearing sleeves without any additional components, without the need for a separate seal between the battery cells and the base body or the bearing sleeves. The temperature control device according to the invention thus facilitates the use of liquid cooling fluids, which usually have better thermal conductivity properties than gaseous ones. The bearing sleeves also form burst protection to prevent the battery cells from bursting on the jacket side in the event of a thermal runaway. The openings according to the invention can be easily manufactured on a wall section of the base body and also facilitate the manufacture or positioning of the bearing sleeves, since the openings according to the invention form a passage to the bearing sleeves. It is essentially irrelevant whether the bearing sleeves are formed integrally with the base body or are inserted into the base body as separate components and, for example, connected to it in a form-fitting manner. The arrangement of the receiving openings and bearing sleeves according to the invention also allows greater design freedom in the arrangement of the flow channel. In a preferred embodiment, the main flow direction of the flow channel can run transversely to the longitudinal axis of the bearing sleeves, so that the flow passes around them and the heat transfer from the battery cells via the bearing sleeve to the cooling fluid is improved. Simple manufacturing is further facilitated if the wall section of the base body, and preferably the entire base body, is made of thermoplastic material. In a preferred embodiment, a flow divider is provided in the flow channel, which divides the flow channel into several sections, whereby the cooling fluid flows through these sections one after the other and always flows around only one outer wall section of the bearing sleeves in the flow channel in each section. Since the cooling fluid flows around the bearing sleeves one after the other, but in each section only around one outer wall section and not the entire outer wall, the temperature spread between the battery cells can be reduced. In a preferred embodiment, the bearing sleeves are made of mono- or copolymeric thermoplastic material, for example polyolefin, polyvinylidene fluoride, polytetrafluoroethylene, polycondensates, acrylonitrile butadiene styrenes, or fluoroelastomers, and are stretched, preferably under the influence of heat, so that their free inner diameter expands. To improve thermal conductivity and/or reduce electrical conductivity while simultaneously increasing electrical breakdown resistance, the material may contain fillers, for example carbon black and/or inorganic fillers, in particular mineral-e fillers. The stretching process can be terminated by subsequent cooling so that the expanded free inner diameter of the bearing sleeves is maintained under internal structural stress. After the battery cells have been inserted, the bearing sleeves are heated so that the structural stresses are released and the inner diameter is reduced again, so that the bearing sleeves fit snugly around the battery cells. In one embodiment, the wall section forms a wall of the base body, which wall is pierced by a plurality of receiving openings. This results in a temperature control device for a battery system with a base body and a plurality of bearing sleeves for battery cells, the bearing sleeves being arranged in a flow channel, wherein a wall of the base body is pierced by receiving openings that open into the bearing sleeves, wherein the bearing sleeves are preferably formed from the wall of the base body.

To enable the use of electrically conductive fluids, it is proposed that the bearing sleeves are electrical insulators. Although the bearing sleeves form a physical barrier between the battery cells and the cooling fluid, which in principle impairs heat transfer, it has been found that this apparent disadvantage allows the use of electrically conductive cooling fluids without increasing the risk of a short circuit in the temperature control device. Electrically conductive cooling fluids typically have a thermal conductivity that is so superior to that of electrically insulating cooling fluids that the impeded heat transfer is more than compensated for and, overall, more heat energy can be transferred from the battery cells to the cooling fluid via the bearing sleeve than would be possible without the bearing sleeve on an electrically insulating cooling fluid. This effect is further enhanced when using peeled battery cells, i.e., battery cells whose casing has been at least partially removed to establish electrical contact, since the casing also hinders the dissipation of heat energy from inside the battery cell, thus enabling improved heat transfer in addition to easier electrical contact.

Both the insertion of the battery cells and their storage and the heat transfer to the cooling fluid in the flow channel can be improved if the battery cells are inserted into the bearing sleeves with a press fit. As a result of these measures, the battery cells can be pressed into the bearing sleeves. There is also no need for any additional components, such as a cover or a locking device, to secure the battery cells in the bearing sleeves, as the press fit secures the battery cell by friction and/or form fit when the diameter of the bearing sleeve is selected appropriately. Due to the press fit, the battery cell fits at least partially snugly against the bearing sleeve on the jacket side, facilitating heat transfer via the bearing sleeve into the cooling fluid. In order to create the press fit, the diameter of the bearing sleeve can be smaller than that of the battery cell, at least in sections, before the battery cell is inserted. Preferably, the diameter of the bearing sleeves decreases starting from the receiving openings, so that the press fit can be created simply by pressing in the battery cell when fitting it and the bearing sleeve fits snugly around the circumference of the battery cell when it is inserted. In a preferred embodiment, at least one vent channel is provided on the jacket side of each bearing sleeve through which the air escaping from the bearing sleeve during the press fit can be discharged. This vent channel can be arranged on the bearing sleeve in such a way that it causes turbulence in the cooling fluid as it flows around the bearing sleeve, thereby further improving the heat transfer from the battery cell via the bearing sleeve to the cooling fluid.

In order to facilitate the electrical contacting of the battery cells and to fix them more securely in place mechanically, it is proposed that the bearing sleeves have a sleeve base opposite the receiving openings. The sleeve base forms a stop for the battery cell along its longitudinal axis, so that the battery cell is positively secured in this direction. This makes it easy to define a uniform maximum bearing depth for the battery cells in their respective bearing sleeves. As a consequence, each battery cell protrudes the same distance from its assigned receiving opening, which facilitates electrical contact, for example by means of a contact plate. In a special embodiment, each bearing sleeve has a hole in its sleeve base through which, for example, a pole of the battery cell can be contacted or which serves as a degassing valve.

In order to simplify mechanical and electrical access to the battery cells inserted into the bearing sleeves without impairing the flow channel, in particular its fluid tightness, the sleeve base can form an outer wall section of the base body. As a result of these measures, the sleeve base is not located within the flow channel, so that manipulation of the sleeve base does not result in leakage of the flow channel and/or an electrical connection between the cooling fluid and the battery cell. This allows the sleeve base to be easily manipulated from the outside without impairing the functionality of the temperature control device. If, for example, a hole is provided in the sleeve base for electrical contact, this contact can be easily made via an external component, such as a contact plate, without having to insert it into the flow channel.

In order to minimize damage to the temperature control device in the event of battery cell malfunctions, such as thermal runaway, it is proposed that the sleeve base be equipped with a degassing valve. As a result of these measures, the kinetic energy released by gas escaping during a malfunction is not transferred to the bearing sleeve on the jacket side, but can be dissipated via the degassing valve at the sleeve base. Depending on how the temperature control device is manufactured, the escaping gas is directed into the flow channel and can be dissipated with the cooling medium. Preferably, the sleeve base forms an outer wall section of the base body so that escaping gas is discharged from the temperature control device without entering the flow channel and contaminating the cooling fluid. In the simplest case, the degassing valve is a predetermined breaking point at the sleeve base. In a preferred embodiment, the degassing valve is a mechanical valve so that the temperature control device is not damaged even during degassing of a battery cell. In a particularly simple embodiment, the degassing valve is a bursting diaphragm.

The number of components in the temperature control device, and thus the number of seals required, can be minimized if the bearing sleeve is formed from the wall section of the base body. In the context of the invention, “formed” means that the bearing sleeve is formed from the wall section in a single forming step. As a result of these measures, at least the wall section of the base body and the bearing sleeves can be designed as a single piece, which means that these components do not need to be connected to each other, nor do fluid-tight seals need to be provided. Another advantage of this is that the forming process reduces the wall thickness in the area of the bearing sleeve, which allows for better heat transfer from the battery cells via the bearing sleeve to the cooling fluid. In the simplest case, the entire temperature control device can be formed in one piece from a hollow body by manufacturing the bearing sleeves by pressing, whereby the flow channel forms automatically inside the base body without any further manufacturing measures. Preferably, the bearing sleeves are formed in such a way that a sleeve base is also formed during the manufacturing step. A forming step can be reshaping. The bearing sleeves can be formed by deep drawing, for example. A plurality of bearing sleeves can be formed from the wall section so that at least two bearing sleeves are formed integrally with each other. In this way, the bearing sleeves can be easily inserted together into the flow channel. An easily assembled temperature control device is obtained when the wall section with the bearing sleeves forms a removable wall of the base body.

So that conventional manufacturing and forming methods can be easily used to manufacture the temperature control device, it is proposed that the base body is composed of two sub-bodies that can be connected to each other in a fluid-tight manner. This allows the two sub-bodies to be designed in such a way that they can be easily manufactured. This also makes it easy to carry out manufacturing steps on the parts of the base body that are difficult to access when assembled, such as the flow channel, before it is assembled in a fluid-tight manner. As a result of these measures, a flow divider, for example, can be easily inserted before assembly. The two sub-bodies can, for example, be manufactured from two plates that are formed and then connected to each other. The fluid-tight connection can be made by welding and/or using seals. Particularly simple manufacturing conditions result when the sub-bodies are made of thermoplastic material and are joined together by welding. Preferably, one sub-body forms the wall section penetrated by the receiving openings, which together with the second sub-body delimits the flow channel. In the simplest case, the wall section can consist solely of a plate that can be easily processed using conventional manufacturing methods such as pressing or deep drawing. This allows the receiving openings and, preferably, also the bearing sleeves to be manufactured on the first sub-body without great effort. The second sub-body is designed to complement the first sub-body in such a way that, after assembly, both delimit the flow channel. For this purpose, the second sub-body can be designed to be essentially trough-shaped, which also facilitates manufacture by means of pressing, deep drawing, or the like.

Another easy-to-manufacture and mechanically particularly stable two-part embodiment results when the end sections of the bearing sleeves opposite the receiving openings are connected to the second sub-body in a fluid-tight manner. As a result of these measures, the bearing sleeves do not necessarily have to have sleeve bases, which simplifies manufacturing. The fluid-tight connection of the end sections of the bearing sleeves to the second sub-body not only creates a fluid-tight flow channel, but also connects both sub-bodies to each other at each bearing sleeve, thereby stiffening the entire temperature control device. If one sub-body forms the bearing sleeves, their end sections can be welded to the second bearing body, for example. If this is not the case, the bearing sleeves can be welded to both sub-bodies. Preferably, the second sub-body forms a base for the bearing sleeves, which performs the same function as a sleeve base.

In order to enable sufficient protection of the battery cells in the event of thermal runaway despite the low-cost manufacture of the device, it is proposed that one bearing sleeve be provided for each battery cell. In this way, the battery cells are spatially shielded from each other, with the bearing sleeves forming a protective barrier between the adjacent battery cells. In particular, if the bearing sleeves completely enclose the battery cells, an effective protective barrier can be achieved to shield defective battery cells. Preferably, the battery cells are sealed against each other in a fluid-tight manner by the bearing sleeves in order to prevent any escaping hot gas from spreading towards the adjacent battery cells.

Preferred conditions for simple manufacturing can be achieved by designing the bearing sleeves as hollow cylinders, in particular with a circular base. In this way, corners and edges, which lead to insufficiently accurate results, especially in forming processes such as deep drawing, can be reduced.

### BRIEF DESCRIPTION OF THE INVENTION

The drawing shows an example of the invention, wherein

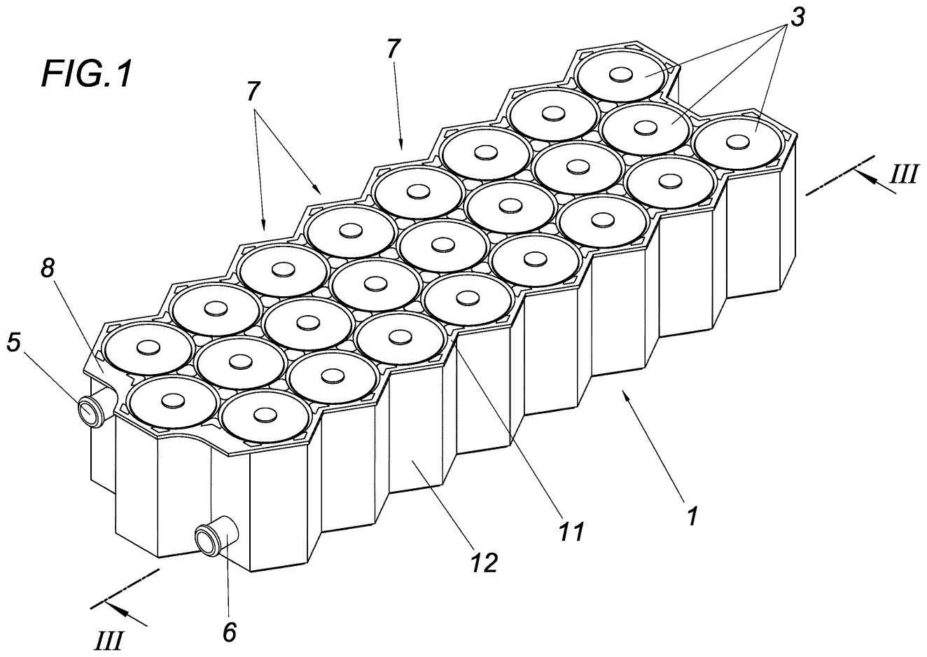

FIG. 1 shows an isometric view of a temperature control device according to the invention with inserted battery cells,

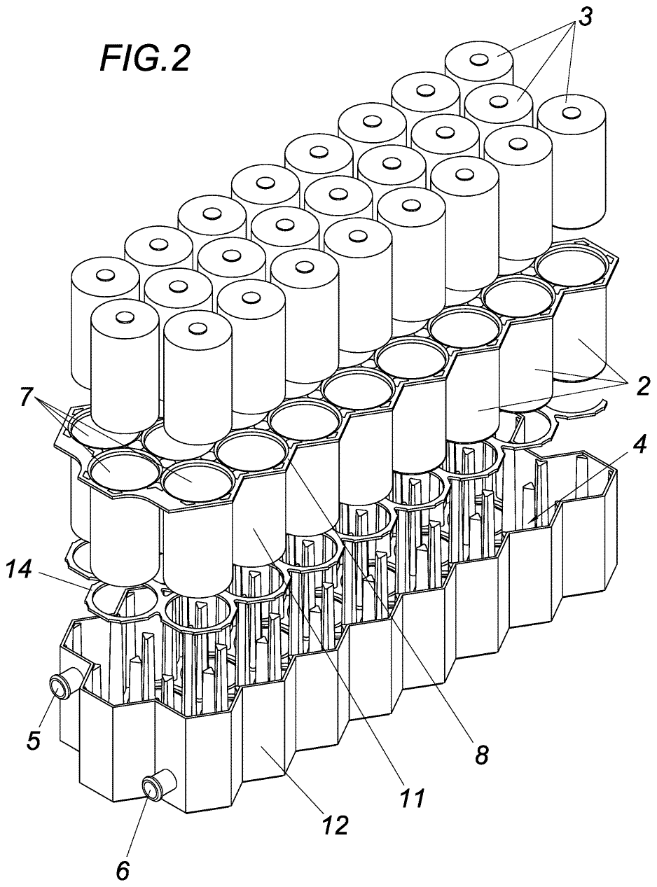

FIG. 2 shows an exploded view of the temperature control device according to the invention in FIG. 1, and

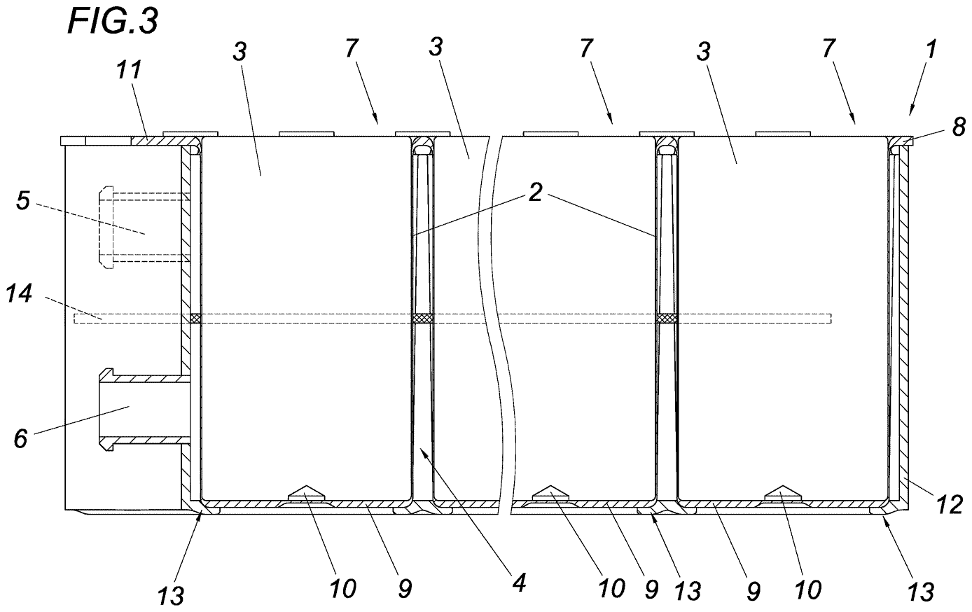

FIG. 3 shows a section along line III-III of FIG. 1 on a larger scale.

### DESCRIPTION OF THE PREFERRED EMBODIMENTS

A temperature control device according to the invention comprises a base body 1 and several bearing sleeves 2 for battery cells 3. The base body 1 forms a fluid-tight flow channel 4, which has an inlet 5 and an outlet 6 and is filled with a cooling fluid during operation, which flows around the bearing sleeves 2. Efficient cooling fluids, i.e., those that ensure good heat transfer between battery cell 3 and the cooling fluid, are usually electrically conductive. However, if the bearing sleeves 2 are electrical insulators, such cooling fluids can still be used. This advantage of improved heat transfer outweighs the disadvantage of the bearing sleeve 2 as an additional intermediate layer between the battery cell 3 and the cooling fluid. If the battery cells 3 are inserted into the bearing sleeves 2 with a press fit so that, as shown in the figures, the bearing sleeves 2 fit snugly around the entire circumference of the battery cell casings, the disadvantage described above is further reduced by the large interaction surface available for heat transfer. In order to remove the air present in the bearing sleeve 2 during the press fit, vent channels (not shown) may be provided on the jacket side of the bearing sleeves 2, which preferably also induce turbulence in the cooling fluid in the flow channel 4 in order to improve heat transfer. If the bearing sleeves 2 are formed from the wall section 8 of the base body 1, for example by deep drawing, as shown, this offers, in addition to simplified manufacturing, the further advantage that, due to the material and manufacturing process, the walls of the bearing sleeves 2 are thinner than the wall section 8, thereby reducing the thermal insulation properties of the bearing sleeves 2 as desired, but without impairing the necessary electrical insulation.

In order to store the battery cells 3 in the bearing sleeves 2, they are pressed into the bearing sleeves 2 via receiving openings 7. According to the invention, these receiving openings 7 are openings in a wall section 8 of the base body 1 and preferably have a sleeve base 9 opposite the receiving openings 7, which serves as a stop for the battery cells 3. The sleeve base 9 can also form an outer wall section of the base body 1, so that the inserted battery cell 3 remains accessible via the sleeve base 9. In the event of a malfunction, gases escaping from the battery cells 3 can thus be conducted out of the temperature control device via a degassing valve 10, thereby preventing these gases from contaminating the cooling fluid in the flow channel 4.

The base body 1 of the embodiment shown is composed of two sub-bodies 11, 12 in order to facilitate manufacture. These two sub-bodies 11, 12 are connected to each other in a fluid-tight manner, for example by welding. One sub-body 11 forms the wall section 8 pierced by the receiving openings 7, which together with the second sub-body 12 delimits the flow channel 4. Regardless of whether sleeve bases 9 are provided for the bearing sleeves 2 or not, the end sections 13 of the bearing sleeves 2 can be connected to the second sub-body 12 in a fluid-tight manner, which stiffens the temperature control device.

Another advantage of using two sub-bodies 11, 12 is that a flow divider 14 can be used without high manufacturing costs. The flow divider 14 allows the inlet 5 and outlet 6 to be arranged on the same end face of the base body 1, while still ensuring that all battery cells 3 are flowed around evenly. The greater advantage, however, is that the flow divider 14 divides the flow channel 4 into two parallel sections, which are passed through by the cooling fluid one after the other. In each section, the cooling fluid always flows around either the upper or lower half of the battery cells 3, but passes each battery cell 3 twice, which reduces the temperature gradient between the battery cells 3 and the cooling fluid at the outlet 6 and thus reduces the temperature spread of the battery cells 3 within the temperature control device.

In particular, it can be seen from FIG. 2 that each battery cell 3 can have its own bearing sleeve 2, whereby the bearing sleeves 2 completely enclose the battery cells 3. In this way, the battery cells 3 can be sealed against each other in a fluid-tight manner by the bearing sleeves 2.

In a preferred embodiment, the bearing sleeves 2 are formed in one piece with each other. The wall section 8 from which the bearing sleeves 2 are formed can form a wall for the base body 1 connecting the bearing sleeves 2 to each other.

Preferred manufacturing conditions, particularly with regard to forming processes, result when the bearing sleeves 2 are designed as hollow cylinders, particularly with a circular base.

1. A temperature control device for a battery system, said device comprising:
a base body and a plurality of bearing sleeves receiving battery cells;
the plurality of bearing sleeves being arranged in a flow channel;
wherein a wall section of the base body is pierced by a receiving opening that opens into one bearing sleeve of said plurality of bearing sleeves; and
wherein said one bearing sleeve is formed from the wall section of the base body.

2. The temperature control device according to claim 1, wherein the bearing sleeves are electrical insulators.

3. The temperature control device according to claim 1, wherein the battery cells are inserted into the bearing sleeves with a press fit.

4. The temperature control device according to claim 1, wherein the bearing sleeves each have a respective sleeve base opposite the receiving opening.

5. The temperature control device according to claim 4, wherein the sleeve base forms an outer wall section of the base body.

6. The temperature control device according to claim 4, wherein the sleeve base has a degassing valve.

7. The temperature control device according to claim 1, wherein the base body is composed of first and second sub-bodies configured to be connected to each other in a fluid-tight manner.

8. The temperature control device according to claim 7, wherein the first sub-body forms the wall section pierced by the receiving openings, that together with the second sub-body delimits the flow channel.

9. The temperature control device according to claim 7, wherein end sections of the bearing sleeves opposite the receiving openings are connected to the second sub-body in a fluid-tight manner.

10. The temperature control device according to claim 1, wherein each bearing sleeve is associated with a respective one of the battery cells.

11. The temperature control device according to claim 1, wherein the bearing sleeves completely enclose the battery cells.

12. The temperature control device according to claim 1, wherein the battery cells are sealed against each other in a fluid-tight manner by the bearing sleeves.

13. The temperature control device according to claim 1, wherein at least two of the bearing sleeves are formed integrally with one another.

14. The temperature control device according to claim 1, wherein the bearing sleeves are of a hollow cylindrical shape.

15. The temperature control device according to claim 2, wherein the bearing sleeves each have a respective sleeve base opposite the receiving opening.

16. The temperature control device according to claim 15, wherein the sleeve base forms an outer wall section of the base body.

17. The temperature control device according to claim 5, wherein the sleeve base has a degassing valve.

18. The temperature control device according to claim 4, wherein the base body is composed of first and second sub-bodies configured to be connected to each other in a fluid-tight manner.

19. The temperature control device according to claim 7, wherein the first sub-body forms the wall section pierced by the receiving openings, that together with the second sub-body delimits the flow channel.

20. The temperature control device according to claim 19, wherein end sections of the bearing sleeves opposite the receiving openings are connected to the second sub-body in a fluid-tight manner.
